(19) United States
(12) Patent Application Publication
(10) Pub. No.: US 2008/0295368 A1
(43) Pub. Date: Dec. 4, 2008

(54) Positionable display

(76) Inventor: John Klotnia, Brooklyn, NY (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 12/190,292

(22) Filed: Aug. 12, 2008

(51) Int. Cl. G09D 3/08; G09F 9/37

(52) U.S. Cl. 40/113; 40/492

(57) ABSTRACT

A new calendar that has separate sets of plates that bear the symbols representing the information. For example, one set of plates bears the names of the months of the year (or abbreviations of those names), another set of plates bears numerical dates, and another set of plates bears an indicator of the days of the week. The plates are arranged in a stack, with at least some of the plates covering the symbols on underlying plates. Separate, axially offset hinges enable selected plates to be rotated with respect to other plates, revealing the symbols on the selected plates while the symbols on other plates remain covered. The hinges enable a user to rotate the stack to a position where a selected plate in an upper set of plates is exposed while any overlying plates remain positioned behind a top cover plate and any underlying plates in the upper set of plates remain positioned behind the exposed plate. A selected plate in a lower set of plates can be exposed while any overlying plates in that set of plates remain positioned behind the exposed plate from the upper set of plates and any plates underlying the lower exposed plate remain positioned behind the lower exposed plate.

### CROSS-REFERENCE TO RELATED APPLICATIONS

Not applicable.

### BACKGROUND OF THE INVENTION

The present invention relates generally to mechanical structures used to display visual information, including, for example, calendars that display the current month, date, and/or day of the week.

### BRIEF SUMMARY

The applicant has developed a new mechanical structure that can be used for calendars and other products that visually display information.

The structure has separate sets of plates that bear the symbols representing the information. For example, one set of plates bears the names of the months of the year (or abbreviations of those names), another set of plates bears numerical dates, and another set of plates bears an indicator of the days of the week. The plates are arranged in a stack, with at least some of the plates covering the symbols on underlying plates. Separate, axially offset hinges enable selected plates to be rotated with respect to other plates, revealing the symbols on the selected plates while the symbols on other plates remain covered.

Specifically, the hinges enable a user to rotate the stack to a position where a selected plate in an upper set of plates is exposed while any overlying plates remain positioned behind a top cover plate and any underlying plates in the upper set of plates remain positioned behind the exposed plate. A selected plate in a lower set of plates can be exposed while any overlying plates in that set of plates remain positioned behind the exposed plate from the upper set of plates and any plates underlying the lower exposed plate remain positioned behind the lower exposed plate.

### BRIEF DESCRIPTION OF THE DRAWINGS

The invention may be better understood by referring to the accompanying drawings, in which:

FIG. 1 is a perspective view of a calendar that uses the invention.

FIG. 2 is a top plan view of the calendar in a closed, stacked position.

FIG. 3 is a top plan view of the calendar in a rotated, display position.

FIG. 4 is a front elevational view of the calendar in the display position.

FIGS. 5 and 6 are front views of the calendar in a partially-open position.

FIG. 7 is an exploded perspective view of the calendar.

FIG. 8 is a front view of the display in an intermediate position.

### DETAILED DESCRIPTION

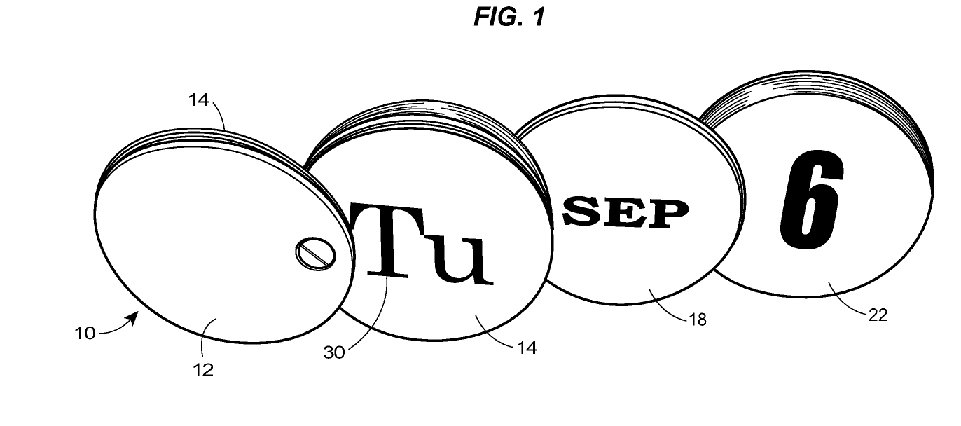

The figures illustrate one embodiment of a display that uses the new invention. The illustrated display is a calendar 10. As seen in FIGS. 1-3 the illustrated calendar has a front cover plate 12, an upper set of plates 14, a front divider plate 16, a middle set of plates 18, a back divider plate 20, a lower set of plates 22, and a back cover plate 24.

The size and shape of the plates in the three sets of plates 14, 18, and 22 can vary. In this example, the plates are made of thin plastic, are circular in profile, and have a diameter of approximately 3 inches. Other sizes and shapes are possible. In this example, all of the plates are the same general size and shape, but this is not always necessary, and may not always be preferred.

Each of the plates bears a symbol 30. In this example, the plates in the upper set of plates 14 bear a symbol 30 that represents a day of the week. One plate bears the letter “M” (representing “Monday”), one plate bears the abbreviation “Tu” (representing “Tuesday”), another bears the letter “W” (representing “Wednesday”), another bears the abbreviation “Th” (representing “Thursday”), another bears the designation “F” (designating “Friday”), another bears the abbreviation “Sa” (representing “Saturday”), and another bears the abbreviation “Su” (representing “Sunday”). Variations are possible. For example, other symbols or the full name of the day of the week could be used, weekend days could be omitted or combined onto a single plate, etc.

In this example, the plates in the middle set of plates 18 bear symbols 30 that represent the months of the year. One plate bears the abbreviation “Jan” (representing “January”), one plate bears the abbreviation “Feb” (representing “February”), etc. Again, variations are possible. For example, other symbols or the full name of the month could be used, certain months could be omitted or combined onto a single plate, etc.

The plates in the lower set of plates 22 in this example bear symbols 30 that represent the dates of the month. One plate bears the number “1”, another bears the number “2”, etc. Again, variations are possible. In this case, separate sets of plates could be used for the first and second digit of the date; in other words, one set of plates could bear the digits 0-9 while another set of plates includes a blank plate and plates bearing the digits 1-3 (for the “tens” place).

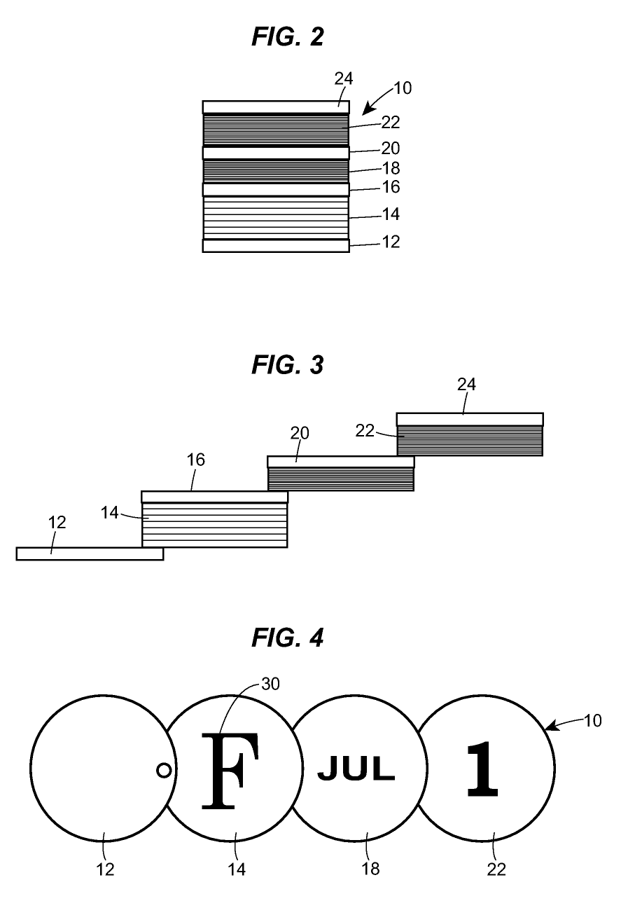

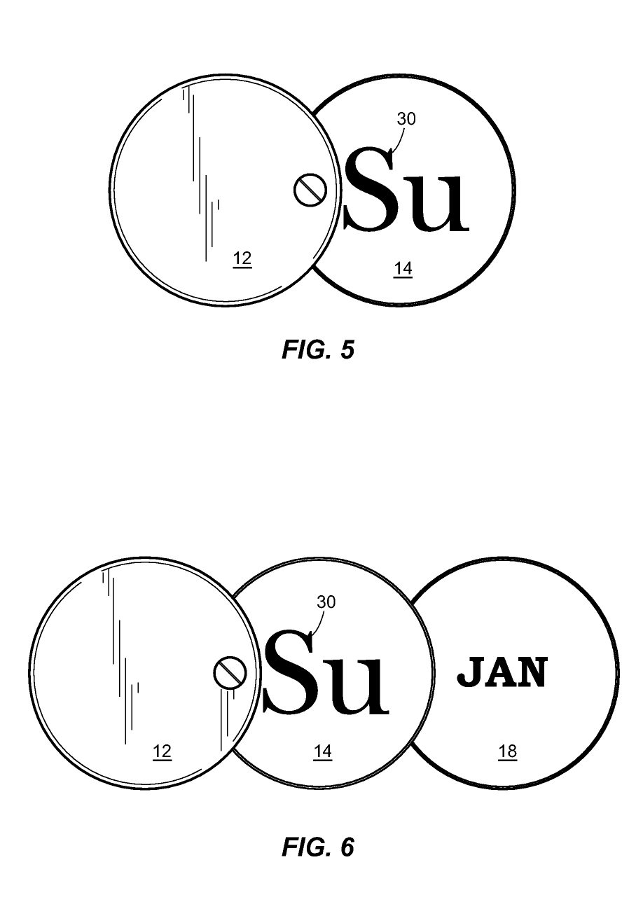

The plates are arranged in a stack, with at least some of the plates covering the symbols on the plates below. In FIG. 2, for example, all the plates are located directly behind the front cover plate 12. In FIGS. 3-5, the plate bearing the letter “F” from the upper set of plates 14 has been rotated out from behind the front cover plate. (The plates behind that plate have also been rotated.) The hinge that enables this movement will be described in more detail below.

In FIG. 6, the plate bearing the abbreviation “Jul” has been further rotated out from behind the “F” plate. The plates between the “F” plate and the “Jul” plate remain positioned behind the “F” plate

In FIG. 1, the final position is seen. The plate bearing the number “1” has been further rotated out from behind the “Jul” plate. The plates between the “Jul” plate and the “1” plate remain positioned behind the “Jul” plate, and the plates behind the “1” plate are behind the “1” plate. As a result of these rotations, the symbols “F”, “Jul”, and “1” (representing “Friday, July 1”) are visible, while the symbols on all other plates remain hidden.

In this example, three hinges are used to connect all the plates together. One hinge enables a plate bearing a selected day of the week to be rotated laterally out from the stack, revealing the day of the week, while plates bearing other days of the week remain covered. Another hinge enables a plate bearing a selected month to be rotated laterally out from the stack, revealing the selected month while plates bearing other months remain covered. A third hinge enables a plate bearing a selected date to be rotated laterally out from the stack, revealing the selected date while plates bearing other dates remain covered.

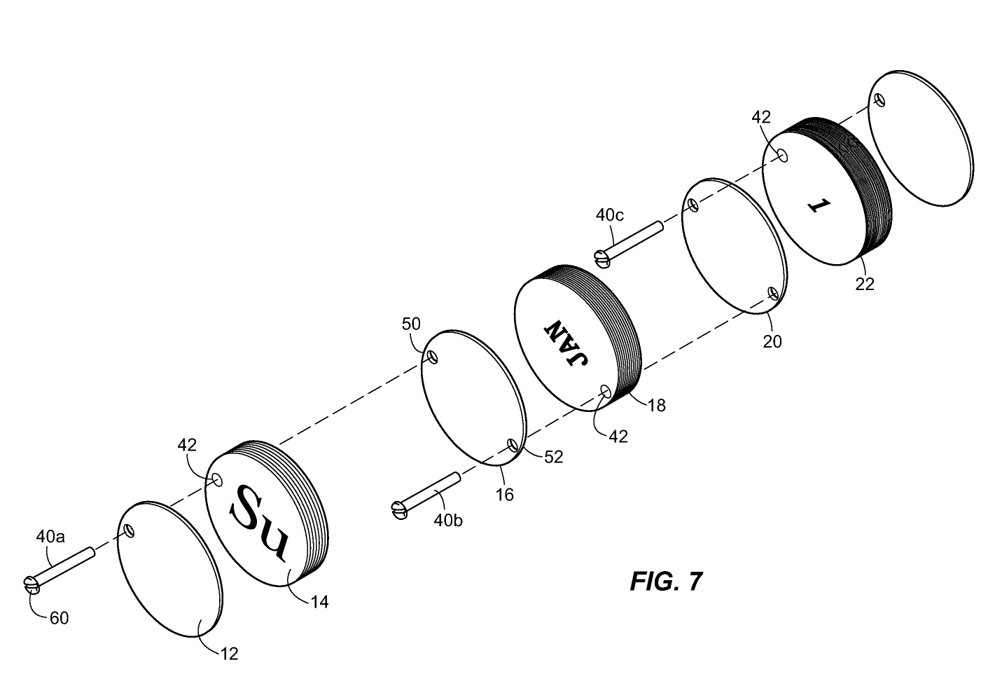

As seen in FIG. 7, all the plates in the illustrated calendar 10 are hinged on one lateral side, in this case, the side to the left of the symbol 30 on the plate. Although other types of hinges can be used, in this case the hinge takes the form of a hub 40 that extends through apertures 42 in each of the plates, enabling the plates to rotate within a plane. The hub used in this example has a circular cross-section and is approximately ⅛″ in diameter. The apertures in this example are also circular in cross-section, and are sized to permit the desired rotation. Other shapes and arrangements of the hub and apertures can be used, but it will usually be preferred for either the hub or the apertures to be generally circular in cross section.

The hub 40a that hinges together the plates in the upper set of plates 14 is connected to the front cover plate 12. In this case, the front cover plate is approximately ⅛″ inch thick and has a recess in which a head 60 on one end of the hub is seated. The opposite end of the illustrated hub is similarly connected to the front divider plate 16. In the illustrated example, the end of the hub is threaded, and fits into a seated nut on the divider plate. In assembling the display, the hub is extended through the recess in the front plate and the apertures 42 in all the plates in the upper set of plates, and then threaded into the seated nut. Once connected in this way, these plates are held together in the stack, and can be rotated as needed.

In addition to securing one end of the hub 40a that hinges the plates in the upper set of plates 14, the front divider plate 16 also secures an end of the hub 40b that hinges the plates in the middle set of plates 18. As best seen in FIG. 7, the hub 40a that holds the upper set of plates extends forwardly from one lateral side 50 of the front divider plate, while the hub 40b that holds the middle set of plates extends rearwards from the opposed lateral side 52 of the same plate. Thus, the two hubs are axially offset. The middle plates are hinged to the middle hub in the same way that the upper plates are hinged to the first hub. Because the hubs 40a and 40b are axially offset and each of the plates is hinged on the left side of the symbol 30 on the plate, when the plates are stacked directly on top of each other, the symbols on one set of plates are inverted with respect to the symbols on the other set of plates. However, when the two sets of plates are rotated out of the stack, the symbols align, as seen in FIG. 1.

Putting the apertures 42 on opposite lateral sides of the divider plates enables the plates to be exposed in a straight-line configuration. It is also possible to arrange the apertures at other offset positions. For example, positioning the apertures at rotations enables the display to be arranged in a triangular 60° configuration, and positioning them at 90° rotations may enable four sets of plates to be positioned in a square configuration.

The lower divider plate 20 is arranged like the upper divider plate 16. The middle hub 40b extends forwardly from one lateral side of the second divider plate (holding the second set of plates between the two divider plates), while a lower hub 40c extends rearwards from an opposed lateral side of the second divider plate. The plates in the lower set of plates 22 are hinged to the lower hub. In this example, when the plates are arranged in a single stack, the symbols 30 on the upper set of plates 14 and the symbols on the lower set of plates 18 are aligned. In this arrangement, rotating the middle set of plates 16 180° from the upper set of plates, and then rotating the lower set of plates 180 degrees from the middle set of plates results in the symbols on the upper set of plates again aligning with the symbols on the lower set of plates.

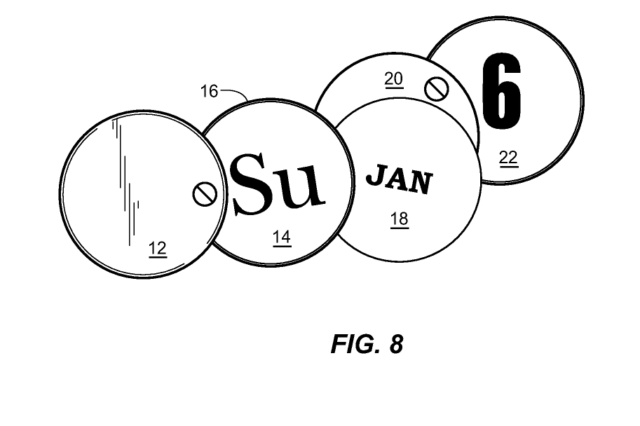

Thus, in this example, to indicate “Friday, July 1”, (as seen in FIG. 1, the stack is rotated to a position where a selected plate bearing a symbol for “Friday” has been rotated out of the stack, exposing the “F” symbol. Overlying plates in the upper set of plates 14 remain hidden behind the top cover plate 12, while underlying plates in the upper set of plates remain hidden behind the exposed “F” plate. Plates are further rotated to a position where a selected plate bearing a symbol for “July” has been further rotated, exposing the “Jul” symbol. The front divider plate 16 and any overlying plates in the middle set of plates 18 remain hidden behind the “F” plate. Underlying plates from the middle set of plates remain hidden behind the “Jul” plate. Plates in the lower set of plates 22 are further rotated to a position where a selected plate bearing a symbol for the first day of the month is visible, exposing the “1” symbol. The lower divider plate remains hidden behind the “Jul” plate. If there were any other overlying plates in the lower set of plates (in this example, there aren't), they would also remain hidden behind the “Jul” plate. Underlying plates in the lower set of plates and the optional back cover plate 24, as seen in FIG. 8, remain hidden behind the exposed “1” plate.

In this example, the divider plates 16, 20 do not bear any of the symbols 30 used for displaying the date. While symbols could be placed on the divider plates, in this example the hub 40 hinging the underlying set of plates is visible from the front side of the divider plate, and would be seen if the divider plate were the top plate in the set of plates rotated out of the stack. For aesthetics, this may not be desired. In addition, the use of a distinct divider plate (in this example, the divider plate is wider than and colored differently than the plates that bear symbols) provides a visual indicator of the boundaries of each of the sets of plates. This visual indicator may help a user to find a desired plate.

This description of various embodiments of the invention has been provided for illustrative purposes. Revisions or modifications may be apparent to those of ordinary skill in the art without departing from the invention. The full scope of the invention is set forth in the following claims.

1. A display that has:
symbols on two separate sets of plates that are arranged in a stack, with at least some of the plates covering the symbols on underlying plates;
two separate, axially offset hinges that enable one selected plate from one set of plates and another selected plate from the other set of plates to be rotated with respect to other plates, revealing the symbols on the selected plates while the symbols on other plates remain covered.

2. A display as recited in claim 1, in which at least one of the hinges has a hub that extends perpendicularly through holes in each of the plates in one of the sets of plates.

3. A display as recited in claim 1, in which each plate rotates within a plane.

4. A display as recited in claim 1, in which:
each of the plates in each of the two sets of plates is hinged on one lateral side;
the display has a divider plate that separates the plates in one set of plates from the plates in the other set of plates;
the divider plate is hinged on one lateral side to the one of the sets of plates, and is hinged at an offset position to the other set of plates.

5. A display as recited in claim 1, in which:
the display is a calendar display;
the symbols on the first set of plates are months of the year;
the symbols on the second set of plates are numerical dates.

6. A display as recited in claim 5, in which:
the display has a third set of plates that bear symbols that represent the days of the week;
each of the plates in each of the three sets of plates is hinged on one lateral side;
the display has a front cover plate;
the display has two divider plates that separate the plates of each set of plates from the plates in the other sets of plates;
the display has three separate hinges;
each of the hinges has a hub that extends perpendicularly through holes in each of the plates in one of the sets of plates;
each of the divider plates is hinged on one lateral side to one of the sets of plates, and is hinged on a laterally opposed lateral side to another of the sets of plates.

7. A calendar display that has the months of a year, the dates of a month, and the days of a week, in which:
the months appear on separate plates;
numerical dates appear on separate plates;
the days of the week appear on separate plates;
the plates are arranged in a stack;
one hinge enables a plate bearing a selected month to be rotated laterally out from other plates, revealing the selected month while plates bearing other months remain covered;
an axially offset hinge enables a plate bearing a selected date to be rotated laterally out from other plates, revealing the selected date while plates bearing other dates remain covered; and
a third hinge enables a plate bearing a selected day of the week to be rotated laterally out from other plates, revealing the selected day of the week while plates bearing other days of the week remain covered.

8. A calendar display that has the months of the year and numerical dates, in which:
the months and dates appear on plates;
the plates are joined together in a stack that includes a front cover plate, an upper set of plates, and a lower set of plates;
the months of the year appear on one of the two sets of plates, and dates appear on the other of the two sets of plates;
the plates in are hinged in a way that enables a user to rotate the stack to a position where (a) a selected one of the plates in the upper set of plates is exposed while any overlying plates remain positioned behind the front cover plate and any underlying plates in that set of plates remain positioned behind the exposed plate, and (b) a selected one of the plates in the lower set of plates is also exposed while any overlying plates in that set of plates remain positioned behind the exposed plate from the upper set of plates and any plates underlying the lower exposed plate remain positioned behind the lower exposed plate.
